(19) United States
(12) Patent Application Publication
(10) Pub. No.: US 2009/0204656 A1
(43) Pub. Date: Aug. 13, 2009

(54) PSEUDO RANDOM NUMBER GENERATOR AND METHOD FOR GENERATING A PSEUDO RANDOM NUMBER BIT SEQUENCE

(75) Inventors: Rainer Goettfert, Taufkirchen (DE); Berndt Gammel, Markt-Schwaben (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 12/030,665

(22) Filed: Feb. 13, 2008

(51) Int. Cl. G06F 7/58

(52) U.S. Cl. 708/252

(57) ABSTRACT

A pseudo random number generator including a plurality of non-singular feedback shift registers each configured to output a bit-sequence. At least a first of the plurality of non-singular feedback shift registers has one or more first cycles of a length less than or equal to two, and a second of the plurality of non-singular feedback shift registers has one or more second cycles of a length less than or equal to two, and the one or more first cycles encompass a first set of one or more of shift-register state vectors 000 . . . , 111 . . . , 010 . . . and 101 . . . and the one or more second cycles encompass a second set of one or more of the shift-register state vectors 000 . . . , 111 . . . , 010 . . . and 101 . . . with the first and the second set being disjoint.

### BACKGROUND

The present invention relates to pseudo random number generators and the generation of a pseudo random bit sequence, and in particular to pseudo random number generators and the generation of pseudo random bit sequences based on a plurality of feedback shift registers.

### BRIEF DESCRIPTION OF THE DRAWINGS

Embodiments of the present invention are described in the following with respect to the figures. Among these figures,

FIG. 1 shows a block diagram of a pseudo random number generator according to an embodiment;

FIG. 2 shows a block diagram of a feedback shift register used as an example for illustrating the non-singularity of non-singular feedback shift registers;

FIG. 3 shows a block diagram of a feedback shift register for illustrating a further example of a non-Singular feedback shift register, and shift register being of type A;

FIG. 4 shows a block diagram of a pseudo random number generator according to a further embodiment;

FIG. 5 shows a block diagram of a pseudo random number generator according to another embodiment; and

FIG. 6 shows a block diagram of a cryptographic apparatus comprising a pseudo random number generator in accordance with a further embodiment.

### DETAILED DESCRIPTION OF THE INVENTION

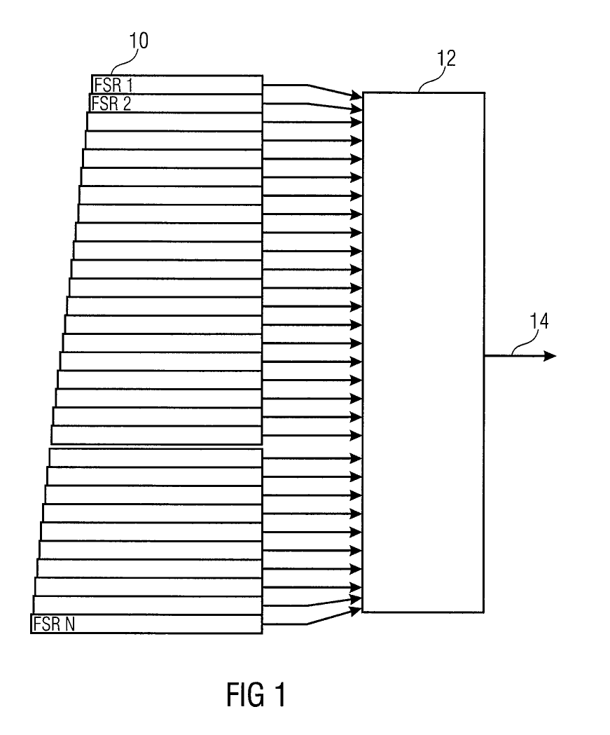

FIG. 1 shows a pseudo random number generator according to an embodiment of the present invention. As can be seen, the pseudo random number generator of FIG. 1 comprises a plurality of feedback shift registers 10 the outputs of which are connected to respective inputs of a combiner or combining circuit 12. The combiner 12 has an output 14 which represents the output of the pseudo random number generator of FIG. 1. The number of feedback shift registers 10 shown in FIG. 1 is merely illustrative and each number of feedback shift registers 10 greater than 1 is possible. Each feedback shift register 10 outputs a pseudo random number sequence of symbols such as bits and combiner 12 combines these pseudo random sequences to obtain a single pseudo random sequence. In order to perform this combination, combiner 12 may be configured to perform a non linear Boolean function and apply this function to the pseudo random sequences output by feedback shift registers 10.

In particular, the feedback shift registers 10 are clocked to output a pseudo random symbol and update an internal state per clock cycle. For example, the feedback shift registers 10 are commonly clocked by the same clock. Combiner 12 may be configured to combine, per clock cycle, a symbol of each of the feedback shift registers 10 to obtain, as an output, a resulting symbol at output 14. In case of bits as symbols, combiner 12 may be configured to bit wise combine bits entering combiner 12 to obtain a single bit. In this case, the bit-rate at which symbols are entering combiner 12 would be N times the bit-rate of the output sequence output at output 14 with N being the number of feedback shift registers 10. However, alternatively, combiner 12 may be designed to operate in another way so that the ratio between the input bit-rate and the output bit-rate differs from 1/N.

Internally, each feedback shift register 10 may comprise a plurality of memory cells connected in series. The memory cells may be configured to store binary values, i.e., 0 or 1. Alternatively, each memory cell may be configured to store a value or symbol of an alphabet R. In order to ease the description below, it is assumed that the memory cells are of binary nature.

The state of the memory cells of a certain feedback shift register 10 at a certain time instance represents the internal state of this feedback shift register 10. The state of all memory cells of all feedback shift registers 10 determines or represents the internal state of the pseudo random number generator of FIG. 1.

As maybe seen from FIG. 1, the feedback shift registers 10 of the pseudo random number generator may exemplarily have different lengths.

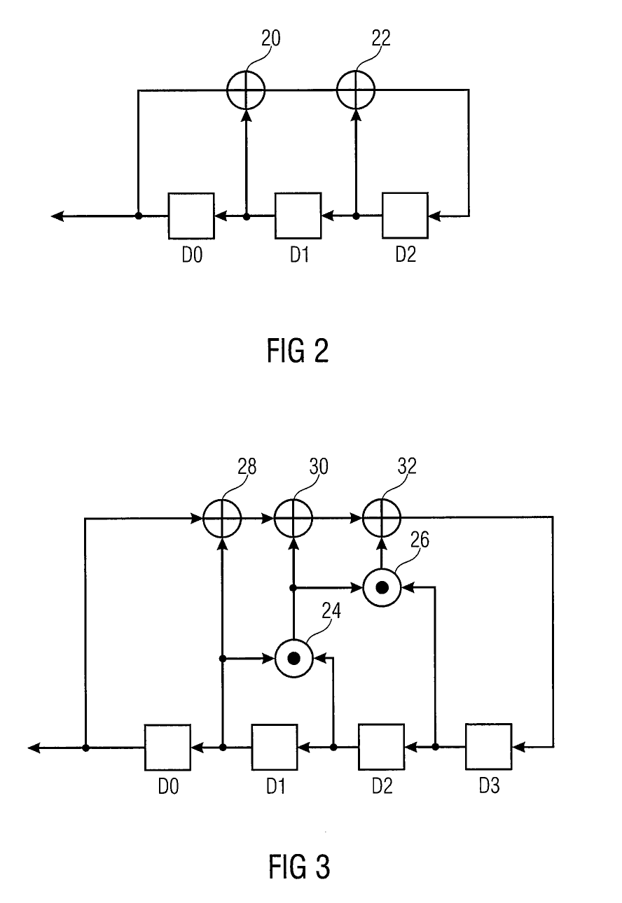

As will become more clear with respect to FIG. 2 to 4, each feedback shift registers 10 may comprise a next-state-function logic which determines the internal state of the respective feedback shift register 10 at clock cycle or time instance t+1 based on the internal state of this feedback shift register 10 at time instance t.

During a normal or free-running operation mode, the feedback shift registers 10 operates in an un-influenced and self-contained manner. That is, no external information influences the internal state of the feedback shift registers 10. However, at some initialization phase, the feedback shift registers 10 are seeded. The internal state of the feedback shift registers 10 at the beginning of the free-running mode, i.e., time instance t=0, is called a seed of the feedback shift registers 10. Accordingly, the internal state of all feedback shift registers 10 at time instance t=0 is the seed of the pseudo random number generator of FIG. 1. In case the pseudo random number generator is used in a cryptographic application, the seed should be unknown to or unpredictable to un-authorised third-parties. The seed source providing the seed could, for example, comprise a true random number generator (TRNG). The true random number generator, in turn, may exploit a physical noise source in order to gain the true random number bit sequence.

As becomes clear from the above, the seed of the pseudo random number generator (PRNG) is a relatively short bit sequence which may be “truly” random. The PRNG, then, generates a long pseudo random sequence out of the seed which may be truly random. That is, the relatively short seed is extended to a relatively long pseudo random sequence. The pseudo random sequence should comply with statistical tests proving that, for example, the number of 0's and 1's within the bit sequence output at output 14 is equal to each other, i.e., the 0's and 1's are equal probable, or that the probability distribution of the 0's and 1's has no bias.

Depending on the next-state-function logic of the feedback shift registers 10, the registers 10 may be linear feedback shift registers (LFSR) or no-linear feedback shift registers (NLFSR). Further, the bit sequences output by shift registers 10 are periodic bit sequences having a certain period length. The operation performed by combiner 12 on the bit sequences output by the plurality of feedback shift registers 10 may be designed such that the period length of the pseudo random bit sequence output at output 14 has a period length greater than or even by far greater than the maximum period length among the feedback shift registers 10. As already noted above, this operation may be a non-linear Boolean combinational function F.

As will be described in more detail below, the feedback shift registers 10 of FIG. 1 are selected among certain types of binary feedback shift registers. However, before describing the association of the feedback shift registers 10 to certain types, these types and the differences among them is explained.

A feedback shift register having n memory cells such as flip-flops is called a n-stage feedback shift register or feedback shift register of length n. F₂ⁿ shall denote the set of all binary n-vectors. That is, F₂ⁿ shall denote the set of all row vectors having n binary coordinates, in following written as (a₁, a₂, a₃, . . . , aₙ)ₙ with aᵢ ε{1 . . . n}. Further, a feedback shift register is non-singular if each possible state of the feedback shift registers has an unique predecessor state. A non-singular feedback shift register could, therefore, also be reversely driven. It may be proved that non-singular feedback shift registers are exactly those feedback shift registers the feedback function F(x₀,x₁, . . . , xₙ) of which has the form

F(x₀,x₁, . . . xₙ)=x₀+G(x₁, . . . , xₙ)

i.e., the variable x₀ is present merely once and is present merely as a linear component. As a precautionary measure only, it is noted that x₀ to xₙ shall denote the content of the sequence of memory cells of the respective feedback shift register with the index denoting the memory cells in the order decreasing in shift direction of the shift register. The function G may be linear or non-linear. The notation used in order to define the non-singular shift registers by the above equation is based on the presumption that the feedback result F is fed back to memory cell n so that the new internal state is (x₁, . . . , xₙ, F(x₀, x₁, . . . , xₙ)) obtained from the current state (x₀, x₁, . . . , xₙ).

Due to the properties of non-singular feedback shift registers, these feedback shift registers induce a class division within set F₂ⁿ with n denoting the length of the feedback shift register. That is, non-singular feedback shift registers of length n divide-up the set F₂ⁿ into disjoint or element-distinct classes. One way to gain this class division is to use the following procedure:

First, the feedback shift register is loaded with any binary vector of length n. This row vector shall be the first element of a class. Then, the shift register is clocked until the feedback shift register assumes the initial state or first element within the class again, i.e., until it holds the first row vector again. The set of the first element and all row vectors occurring therebetween form a class or a cycle of the feedback shift register. If this class is, however, a proper subset of F₂ⁿ the procedure proceeds with loading a different row vector of F₂ⁿ which is not element of the first class, into the feedback shift register in order to initialise the feedback shift register with this different vector. Again, all possible state vectors resulting from this initialisation, form the second class or second cycle. The procedure is performed further until the unity of classes thus obtained equals F₂ⁿ. By this measure, all vectors of F₂ⁿ are found. Further, each vector falls into exactly one class. And again, all classes taken together comprise all F₂ⁿ vectors.

An example of a non-singular feedback shift register is shown in FIG. 2. The feedback shift register of FIG. 2 is of length n=3 and has a feedback function of F(x₀,x₁,x₂)=x₀+x₁+x₂ wherein the operation “+” indicates an XOR operation. In particular, the feedback shift register of FIG. 2 comprises three memory cells D0, D1 and D2 connected in series in order to form a shift register. The output of the last memory cell D0 concurrently forms the output of the feedback shift register of FIG. 2. In accordance with the feedback function, the outputs of registers D0 and D1 are connected to an XOR gate 20 the output of which corresponds to “x₀+x₁” in the formulae describing the feedback function F. The inputs of a further XOR gate 22 are connected to an output of XOR gate 20 as well as the output of the first memory cell D2 when the output of XOR gate 22 is fed back to the input of the first memory cell D2.

The feedback shift register shown in FIG. 2 has the following cycle structure:

cycle 1: {(0,0,0)}
cycle 2: {(1,1,1)}
cycle 3: {(0,1,0)} {(1,0,1)}
cycle 4: {(0,0,1)} {(0,1,1)} {(1,1,0)} {(1,0,0)}
That is, the feedback shift register of FIG. 2 has four cycles, namely two cycles of length one, one cycle of length two and another cycle of length four.

Similarly, another example for a non-singular feedback shift register as shown in FIG. 3. This feedback shift register is of length four, i.e., n=4. Accordingly, its shift register comprises four memory cells D0, D1, D2 and D3. The input signal fed back into the input of the first memory cell D3 is described by the feedback function of the feedback shift register of FIG. 3 which is F(x₀,x₁,x₂,x₃)=x₀+x₁+x₁·x₂+x₁·x₂·x₃). The multiplication “·” between x₁ and x₂, for example, is embodied by AND gates 24. Another multiplication between the result of x₁·x₂ on the one hand and x₃ on the other hand is performed by another AND gate 26. Three XOR gates 28, 30 and 32 perform the “+” operations within the feedback function. The gates 24 to 32 are interconnected and connected to memories D0 to D3 in the way prescribed by the feedback function F and as shown in FIG. 3.

The feedback function of FIG. 3 has three cycles, namely a cycle of length one, a cycle of length 7 and a cycle of length 8. The three cycles are given by

cycle 1: {(0,0,0,0)}
cycle 2: {(1,1,1,1), (1,1,1,0), (1,1,0,1), (1,0,1,0), (0,1,0,1), (1,0,1,1), (0,1,1,1)}
cycle 3: {(0,0,1,1), (0,1,1,0), (1,1,0,0), (1,0,0,0,), (0,0,0,1), (0,0,1,0), (0,1,0,0), (1,0,0,1)}

After having described the properties of non-singular feedback shift registers, in the following, different types of these non-singular feedback shift registers are presented which have special properties which make them advantageous when using them for generating pseudo random bit sequences in combination or, for one of these types, even individually. In particular, the non-singular feedback shift registers of the types described below have a cycle of relatively long length of at least 2^{N}−2. Beside this long cycle, these non-singular feedback shift registers have one or two cycles of length one or two with these short cycles comprising relatively “simple” state vectors selected from the group consisting of the all-one-vector (1,1,1,1), the all-zero-vector (0,0, . . . 0) and two vectors of alternating zeros and ones, namely (1,0,1, . . . ) and (0,1,0, . . . ).

In particular, a feedback shift register of length N shall be of type A if it is a non-singular shift register that has two cycles, namely a cycle of length 2^{N}−1 comprising all vectors out of F₂^{N} less the all-zeros-vector (0,0,0 . . . ) and a cycle comprising merely the all-zeros-vector.

A feedback shift register of length N shall be of type B if it is a non-singular shift register having two cycles among which one cycle has length 2^{N}−1 comprising all vectors out of F₂^{N} less the all-one-vector (1,1,1, . . . ), and among which the other cycle merely comprises the all-one-vector.

A feedback shift register of length of N shall be of type C if it is a non-singular feedback shift register, comprising three cycles, namely one cycle of length 2^{N}−2 comprising all vectors out of F₂^{N} less the all-one-vector (1,1,1, . . . ) and the (all-)zero-vector, one cycle merely comprising the zero vector and another cycle merely comprising the all-one-vector.

Lastly, a feedback shift register of length N shall be of type D if it is a non-singular feedback shift register that has exactly two cycles among which one cycle has length two and comprises vectors (1,0,1, . . . ) and (0,1,0, . . . ) and among which another cycle has length 2^{N}−2 comprising all other vectors out of F₂^{N}.

Individually, the feedback shift registers according to the above-mentioned types A to D are susceptible to different fault attacks or forcing attacks when using these feedback shift registers individually in an cryptographic application. In particular, some of these types are susceptible to fault attacks or forcing attacks which are easier to be performed than others. In so far, the above types are differently secure in cryptographic sense. Independently therefrom, the above types are less secure when used individually or in combination with feedback shift registers of the same type.

Imagine, for example, the PRNG of FIG. 1 would be used in a security controller such as a chip card controller or a secure RFID attack. For example, the PRNG output sequence at output 14 could be used for generating masks against differential power analysis (DPA) attacks or for masking buses against probing attacks. Further, the PRNG of FIG. 1 could be used within a stream cipher. In all these applications, it is important to guarantee that the PRNG output sequence keeps secure, i.e., maintains its pseudo random nature, despite fault attacks or forcing attacks by unauthorised persons.

For example, by use of fault attacks an attacker manipulates one or more data bits stored within memory cells. For example, these bits can be selectively set to one or deleted, i.e., set to zero, or they can be forced to switch uncontrolled or randomly, i.e., so-called random bit flip. The selection among the just-mentioned possibilities by the attacker depends on the capabilities and intention of the attacker. In particular, it is relatively easy to cause neighbouring flip-flops to be deleted at the same time. Further, it is relatively easy to set many neighbouring flip-flops to one.

The just mentioned-attacks are successful as soon as the pseudo random number bit sequence output at output 14 loses its randomness. This is the case if the feedback shift registers 10 do not operate in their long cycles. If, for example, all feedback shift registers 10 are caught in their short cycles, the period length of the bit sequence output at output 14 is also relatively short. However, if the pseudo random number generator of FIG. 1 is used in a cryptographic sense, such a situation endangers the whole system comprising the same. Thus, such a situation has to be avoided. One possibility would be to actively check the contents of the feedback shift registers 10. This, however, would necessitate a relatively large overhead in hardware. For example, if comparators would be provided in order to check the content of a large shift register, the measures or means in order to protect the comparator itself against attacks would necessitate a circuit that is as large as the whole pseudo random number generator itself.

Another possibility would be to use singular feedback shift registers, i.e., shift registers which are not able to operate in reverse sense, and in particular singular feedback shift registers which merely have one single large cycle. These feedback shift registers, however, show a disadvantage in that the implementation necessitates the outputs of all memory cells of the shift register to participate in the feedback function. This, in turn, causes a large implementation, large chip area and a large power consumption due to dynamic hazards.

Thus, all feedback shift registers 10 should operate in their largest cycles possible in order to achieve the strongest pseudo random bit sequence result. However, imagine that all feedback shift registers 10 are of type A in FIG. 1. Feedback shift registers of type A are easily to be constructed since the theory about these is of high performance. However, by definition, feedback shift registers of type A—once in the all-zero-state—stick in that all-zero-state even if the feedback shift register is non-linear. This, in turn, means that initialising such a feedback shift register of type A with a all-zero-state results in an output sequence of just zeros, i.e., results in a zero sequence 000 . . . . That is, as outlined above, unwanted and the security of the system is reduced dramatically. The attacker, in turn, will try to exploit this weakness by urging the memory cells of flip-flops of as much feedback shift registers 10 as possible into the zero state.

Similarly, imagine that the feedback shift registers 10 of FIG. 1 were of type B only. In this case, in all feedback shift registers 10, the all-one-state would be to be avoided and the attacker in turn, would try to gain advantage from this deficiency by urging all memory cells or flip-flops of these feedback shift registers 10 into state one.

The situation is even worse in case of type C. If all feedback shift registers 10 were of type C, the attacker would be successful in circumventing the pseudo randomness provided by pseudo random number generator of FIG. 1 if it would be able to bring the memory cells or flip-flops of the feedback shift registers 10 either into the all-one state or the all-zero state. In contrast thereto, in case of type A or type B feedback shift registers 10, the attacker is merely successful in one of these alternatives, respectively.

In case of all feedback shift registers 10 being of type D, an attacker would successfully shorten the period length of the output sequence of the PRNG of FIG. 1 merely in case the attacker is able to put the feedback shift registers 10 into the state 01010 . . . or 1010101 . . . . However, according to an embodiment of the present invention, the PRNG of FIG. 1 comprises at least one feedback shift with the term being of type D and is by this measure, at least, protected against the easy to perform above-described unidirectional attacks. According to another embodiment, more than one or all of the feedback shift registers 10 are of type D. Compared to the cases where the feedback shift registers 10 are all of type A, all of type B, all of either type A or C, or all of either type B or C, is that the attacker needs to perform the error or forcing attack such that the feedback shift register or feedback shift registers of type D have to be brought into states of different contents, namely the state 1, 0, 1, . . . or 0, 1, 0, . . . what it is more difficult than commonly setting all memory cells of the feedback shift registers to 1 or to 0. Such, these embodiments exploit the fact that a physical attack onto the state of feedback shift registers with the aim to set them commonly into one direction (unidirectional attack), is by far easier than loading a specific bit pattern into the memory cells of the feedback shift registers. In other words, with merely a part of or all of the feedback shift registers 10 being of type D, it is not possible to paralyse the pseudo random number generator of FIG. 1 by use of a unidirectional attack.

According to a further embodiment of the present invention, at least one of the feedback shift registers 10 is of one of types A to D while at least one other of the feedback shift registers 10 is of another of types A to D such that the short cycles of length 1 or 2 of the first type encompasses a set of vectors which is disjoint to the set of state vectors encompassed by the second type. To illustrate this, reference is made to the below table.

| | Type A | Type B | Type C | Type D |
|---|---|---|---|---|
| 0, 0, 0, . . . | x | | x | |
| 1, 1, 1, . . . | | x | x | |
| 0, 1, 0, . . . | | | | x |
| 1, 0, 1, . . . | | | | x |

The table shows the state vectors occurring in any of the short cycles, i.e., the cycles being of length 1 or 2 of any of types A to D, i.e., 0,0,0 . . . , 1,1,1, . . . , 0,1,0, . . . and 1,0,1, . . . . These vectors are listed in the first column. The next four columns show for each of types A to D which of these vectors is comprised by the one or two short cycles of the respective type. For example, the table shows that the short cycle of type A merely comprises the all-zeros vector whereas the short cycle of type B merely comprises the all-one vector and so on.

First, according to the just-mentioned embodiment, the feedback shift registers 10 comprise at least a pair of feedback shift registers of different type among types A to D wherein the crosses for these types in the table do not commonly lie within one row. That is, the feedback shift registers may comprise a pair of feedback shift registers with the feedback shift registers of these pair being of types (A, B), (A,D), (B,D) or (C,D) according to different embodiments. According to even another embodiment, the feedback shift registers 10 comprises at least three feedback shift registers of the types of A to D, namely of type A, type B and type D. Of course, it is possible that all of the feedback shift registers 10 are of any of the types of the just-mentioned pairs, or just-mentioned triplets such as, in case of m FSRs, m₁ being of type A and m₂=m−m₁ being of type B in case of pair (A,B).

Using the just-mentioned feedback shift registers 10 of different types within the PRNG of FIG. 1 enables to reliably avert unidirectional attacks. In particular, when using the just-mentioned embodiments using different types of feedback shift registers within PRNG of FIG. 1, bringing all of the memory cells of the feedback shift registers into a common state, i.e., 1 or 0, does not lead to a state where all feedback shift registers are within any of their short cycles. Rather, at least the feedback shift registers of one of the types stay within a long cycle. Further, the chip area needed for implementing the PRNG of FIG. 1 and the power consumption of the PRNG of FIG. 1 may be kept equally low to the case were merely feedback shift registers of type A are used, since there exist feedback shift registers of types A, B and D with sparse feedback functions.

Imagine, for example, that a feedback shift register of type A is used along with a feedback shift register of type B within the PRNG of FIG. 1. Then, an directional attack could, at maximum, paralyse merely a part of the PRNG, namely the sub-components comprising the feedback shift register of type A or the sub-component comprising the feedback shift register of type B.

For the sake of completeness only, in the following, examples for NLFSRs of type A, type B and type D are given. An NLFSR of length N=5 is, for example, the feedback shift register having the feedback function F(x₀,x₁,x₂,x₃,x₄)=x₀+x₂+x₄+x₁·x₄. An example for an NLFSR of type B is, for example, the NLFSR of length N=6 having the feedback function of F(x₀,x₁,x₂,x₃,x₄,x₅)=1+x₀+x₂·x₅. An example for an NLFSR of type D is the NLFSR of length N=5 having the feedback function of F(x₀,x₁,x₂,x₃,x₄)=1+x₀+x₁+x₂+x₄+x₁·x₃. Another example for a feedback shift register of type D is an affine feedback shift register, i.e. a feedback shift register having a feedback function without multiplications or ANDs but only with additions or XORs, having the length N=6 and the feedback function F(x₀,x₁,x₂,x₃,x₄,x₅)=1+x₀+x₁+x₄+x₅.

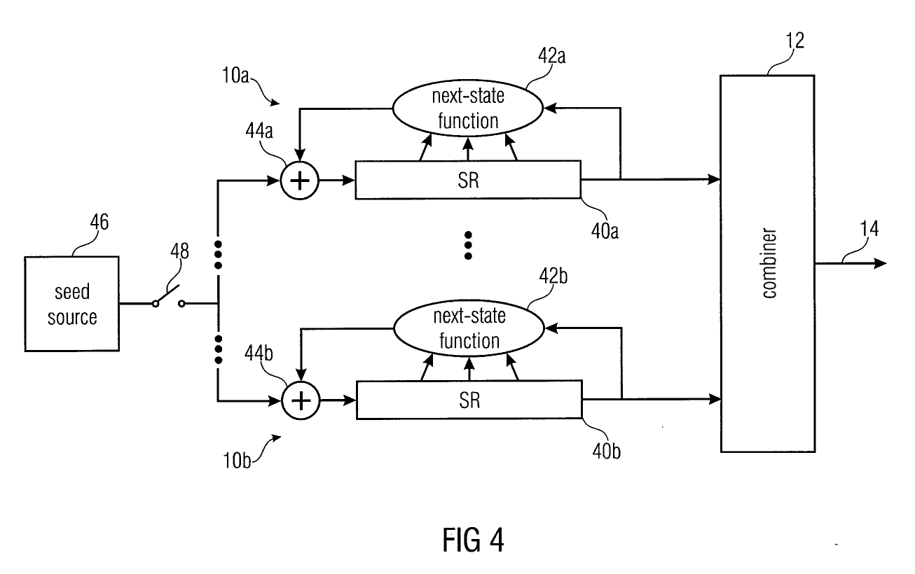

Referring to FIG. 1, the seeding process has not yet been described in detail. In fact, the seeding process may take place in parallel, i.e., by parallely loading the seeding bits into the individual memory cells of the feedback shift registers 10. However, it is also possible to load the seed serially into the individual feedback shift registers of the PRNG. For example, FIG. 4 shows a PRNG constructed in accordance with that of FIG. 1 in more detail to show a possibility for serially loading a seed into the shift registers of the feedback shift registers. In particular, FIG. 4 shows a pseudo random number generator having a plurality of feedback shift registers where the same seed is loaded into the shift registers.

In particular, the PRNG of FIG. 4 comprises a plurality of feedback shift registers wherein, for illustration purposes, merely two such feedback shift registers 10a and 10b are shown in FIG. 4. Furthermore, the PRNG of FIG. 4 comprises a combiner 12, the inputs of which are connected to the outputs of the feedback shift registers 10a and 10b, and the output of which represents the output 14 of the PRNG itself. Each of the feedback shift registers 10a and 10b comprises a shift register 40a and 4b, a next-state function circuitry 42a and 42b and an influencing data 44a and 44b for influencing the output of the next-state function circuitry 42a and 42b, respectively, with a common seed signal which is commonly applied to respective input of the influencing gates 44a and 44b. In particular, the shift registers 40a and 40b of the different feedback shift registers 10a and 10b may have different lengths, i.e., different number of memory cells. The next-state function circuitry 42a and 42b, respectively, is connected to the outputs of specific memory cells of the respective shift register 40a and 40b and is internally constructed in accordance with or as prescribed by the feedback function of the respective feedback shift register 10a and 10b, respectively. The output signal of the next-state function circuitry 42a and 42b comprises a feedback bit entering a respective input of the influencing gate 44a and 44b. In case of FIG. 4, the influencing gate is embodied as an XOR gate. The output of the XOR gates 44a and 44b is connected to the first memory cell of the respective shift register 40a or 40b. Owning to the property of the XOR operation, the influencing gates 44a or 44b influence the feedback bit merely in case the signal at the other input is non-zero. In FIG. 4, the output of the last memory cell of the shift registers 40a and 40b concurrently represents the output of the respective feedback shift register 40a and 40b being connected to the input of combiner 12. However, it is noted that it is also possible to tap another output of one of the other memory cells within the shift registers 40a and 40b in order to obtain the output signal of the respective feedback shift register 40a and 40b. Further, a plurality of memory cell outputs of the shift registers 40a and 40b could be used in order to define the output of the respective feedback shift registers 10a and 10b.

The seed input of each of the influencing gates 44a and 44b are commonly connected to a seed source 46 via a switch 48. The seed source is, for example, a TRNG providing a true random number bit sequence. In case of the switch being closed, the true random bit sequence output by seed source 46 is applied to the seed input of influencing gates 44a and 44b so that during this situation of switch 48 being closed, the feedback shift registers 10a and 10b are seeded with the same seed.

The feedback shift registers 10a and 10b of the pseudo random number generator of FIG. 4 may be selected among the types A to D in the way indicated above with respect to FIG. 1. In case the feedback shift registers 10a and 10b comprise at least a pair of feedback shift registers being of different types selected among types A to D with the selected types having no state vectors within their short cycles in common, even a fault attack or forcing attack to the seed source 46 to the extent that the seed source merely outputs a stuck-at-one or a stuck-at-zero signal or an alternating signal of alternating ones and zeros, does not lead to a dangerous situation where all the feedback shift registers 10a and 10b are within the short cycle. Rather, at least two of the feedback shift registers would stay in the long cycle.

Finally, it is noted that the embodiments of FIGS. 1 and 4 were of illustrative nature only. For example, the number of feedback shift registers may be varied as long as at least two feedback shift registers are maintained. However, in accordance with another embodiment, the PRGN is not constructed as a bundle of feedback shift registers, the outputs of which are connected to a combiner such as it was the case in FIGS. 1 and 4. Rather, according to different embodiments, the above explained advantages of this specific embodiments do also apply to PRNG's where the feedback shift registers are, for example, not connected in parallel. Therefore, in accordance with another embodiment, the pseudo random number generator comprises a plurality of feedback shift registers which are selected the same way as explained above among types A to D, but with the feedback shift registers being interconnected in a different way such as, for example, in series. An alternative embodiments is, for example, shown in FIG. 5. As can be seen, the PRNG shown in FIG. 5 comprises (exemplarily) two feedback shift registers 10a and 10b, an interconnection circuitry 50 interconnecting the inputs and outputs of the feedback shift registers 10a and 10b, an output 14 for outputting the pseudo random bit sequence obtained by a combination of the pseudo random signals output by both feedback shift registers 10a and 10b and a seed input 52 with the interconnection circuitry 50 being connected between input 52 and output 14. Of course, the PRNG of FIG. 5 may comprise more than two feedback shift registers 10a and 10b and may have different length just as indicated with respect to the above embodiment.

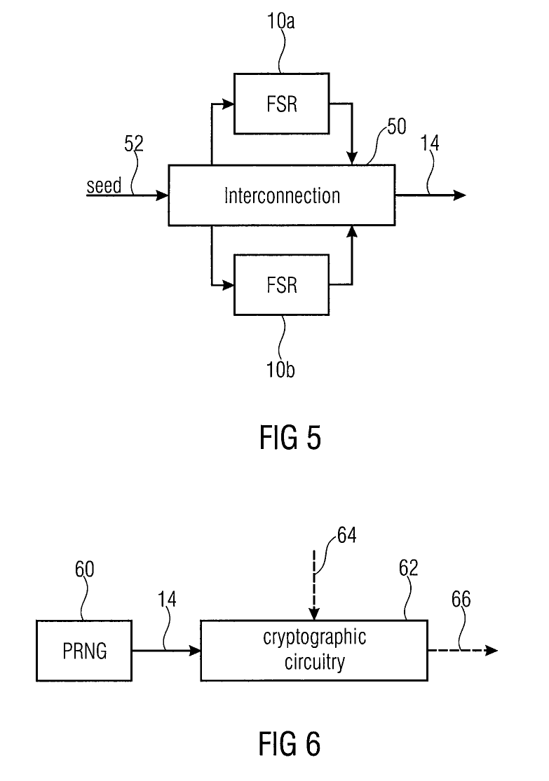

Further, it is noted that the PRNGs presented above with respect to FIGS. 1, 4 and 5 may be used within a stream cipher or another cryptographic entity such as a cryptographic controller. A stream cipher is for generating a sequence of bits which is not only statistically inconspicuous but which is also difficult to crack. That is, it should be almost impossible to compute the seed from pieces of the pseudo random bit sequence even if this piece is long. In connection with stream ciphers, the seed is also called the initial state of the stream cipher. The initial state of a stream cipher may be identical with a secret key or may be derivable easily from the secret key. FIG. 6 shows and embodiment, where a PRNG in accordance with any of the above embodiments and indicated with reference number 60, has its output 14 coupled to a cryptographic circuitry 62. The cryptographic circuitry 62 may be, for example, configured to cryptographically protect data input at a input 64 by means of pseudo random bit sequence entering from output 14 and output the resulting protected bit sequence at an output 66. For example, the cryptographic circuitry 62 encrypts or masks the data input at input 64 per use of pseudo random bit sequence at output 14 and outputs the resulting data at output 66.

Finally, it is noted that the above embodiments where at least a pair of the feedback shift registers are of different types are not restricted to cases where the types of this pair of feedback shift registers is selected from the types A to D. Rather, in accordance within another embodiment, the feedback shift registers 10 of FIG. 1 have at least two feedback shift registers where the unity of state vectors of the small cycle or the small cycles of the one feedback shift register results in a set of state vectors disjoint to the unity of state vectors of the one of more short cycles of the other feedback shift register.

Depending on an actual implementation, the above embodiments can be implemented in hardware or in software. Therefore, they also relate to a computer program, which can be stored on a computer-readable medium such as a CD, a disk or any other data carrier. These embodiments define, therefore, also a computer program having a program code which, when executed on a computer, performs the above methods described in connection with the above figures.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A pseudo random number generator, comprising:
a plurality of non-singular feedback shift registers each configured to output a bit-sequence,
wherein at least a first of the plurality of non-singular feedback shift registers has one or more first cycles of a length less than or equal to two, and a second of the plurality of non-singular feedback shift registers has one or more second cycles of a length less than or equal to two, and
wherein the one or more first cycles encompass a first set of one or more of shift-register state vectors 000 . . . , 111 . . . , 010 . . . and 101 . . . and the one or more second cycles encompass a second set of one or more of the shift-register state vectors 000 . . . , 111 . . . , 010 . . . and 101 . . . with the first and the second set being disjoint.

2. The pseudo random number generator according to claim 1, further comprising a combiner configured to combine the bit-sequences of the plurality of non-singular feedback shift registers into a pseudo random output bit-sequence of the pseudo random number generator.

3. The pseudo random number generator according to claim 1, wherein the first and the second non-singular feedback shift registers are of different lengths.

4. The pseudo random number generator according to claim 1, wherein the first non-singular feedback shift register is of length N₁ and the second non-singular feedback shift register is of length N₂, and the first and second non-singular feedback shift registers are of different types among the types consisting of:
a FSR type comprising a cycle of length 1 comprising the shift-register state vector (1,1,1, . . . )_{N} and another cycle of length 2^{N}−1 comprising all vectors of F₂^{N} except (1,1,1, . . . )_{N},
a FSR type comprising a cycle of length 1 comprising the shift-register state vector (0,0,0, . . . )_{N} and another cycle of length 2^{N}−1 comprising all vectors of F₂^{N} except (0,0,0, . . . )_{N},
a FSR type comprising a first cycle of length 1 comprising the shift-registers state vector (1,1,1, . . . )_{N}, a second cycle of length 1 comprising the shift-register state vector (0,0,0, . . . )_{N}, and another cycle of length 2^{N}−2 comprising all vectors of F₂^{N} except (1,1,1, . . . )_{N}, and (0,0,0, . . . )_{N}, and
a FSR type comprising a cycle of length 2 comprising the shift-registers state vectors (1,0,1, . . . )_{N} and (0,1,0, . . . )_{N}, and another cycle of length 2^{N}−2 comprising all vectors of F₂^{N} except (1,0,1, . . . )_{N}, and (0,1,0, . . . )_{N},
with N ε {N1, N2}.

5. The pseudo random number generator according to claim 2, wherein the combiner is configured to perform a Boolean operation on bits of the bit-sequences.

6. The pseudo random number generator according to claim 2, wherein the combiner is configured to perform a non-linear operation on bits of the bit-sequences.

7. The pseudo random number generator according to claim 2, wherein the combiner is configured to generate the pseudo random output bit-sequence at a bit-rate equal to 1/N of the sum of the bit-rates of the bit-sequences with N being the number of the plurality of non-singular feedback shift registers.

8. The pseudo random number generator according to claim 1, further comprising a switching circuit configured to selectively connect inputs of the plurality of non-singular feedback shift registers with a seed source so that the plurality of feedback shift registers are, with the inputs connected to the seed source, seeded with the same seed.

9. The pseudo random number generator according to claim 1, wherein the first non-singular feedback shift register is of a length N₁ and the second non-singular feedback shift register is of length N₂, and the first and second non-singular feedback shift registers are of different types among the types consisting of:
a FSR type comprising a cycle of length 1 comprising the shift-register state vector (1,1,1, . . . )_{N} and another cycle of length 2^{N}−1 comprising all vectors of F₂^{N} except (1,1,1, . . . )_{N}, and
a FSR type comprising a cycle of length 1 comprising the shift-register state vector (0,0,0, . . . )_{N} and another cycle of length 2^{N}−1 comprising all vectors of F₂^{N} except (0,0,0 . . . )_{N},
with N ε {N1, N2}.

10. The pseudo random number generator according to claim 1, wherein a set of types of all non-singular feedback shift registers of the plurality of non-singular feedback shift registers consists of:
a FSR type comprising a cycle of length 1 comprising the shift-register state vector (1,1,1, . . . )_{N} and another cycle of length 2^{N}−1 comprising all vectors of F₂^{N} except (1,1,1, . . . )_{N},
a FSR type comprising a cycle of length 1 comprising the shift-register state vector (0,0,0, . . . )_{N} and another cycle of length 2^{N}−1 comprising all vectors of F₂^{N} except (0,0,0, . . . )_{N}, and
a FSR type comprising a cycle of length 2 comprising the shift-registers state vectors (1,0,1, . . . )_{N} and (0,1,0, . . . )_{N}, and another cycle of length 2^{N}−2 comprising all vectors of F₂^{N} except (1,0,1, . . . )_{N}, and (0,1,0, . . . )_{N},
with N being the length of the respective non-singular feedback shift register.

11. A pseudo random number generator, comprising:
a plurality of non-singular feedback shift registers each configured to output a bit-sequence, wherein the plurality of feedback shift registers comprises at least one non-singular feedback shift register having a cycle of length 2, comprising shift-register state vectors of (1,0,1, . . . )_{N} and (0,1,0, . . . )_{N} and another cycle of length 2^{N}−2 comprising all vectors of F₂^{N} except (1,0,1, . . . )_{N} and (0,1,0, . . . )_{N} with N being the length of the at least one non-singular feedback shift register.

12. The pseudo random number generator according to claim 11, wherein the plurality of feedback shift registers exclusively comprise non-singular feedback shift registers having a cycle of length 2, comprising shift-register state vectors of (1,0,1, . . . )_{N} and (0,1,0, . . . )_{N} and another cycle of length 2^{N}−2 comprising all vectors of F₂^{N} except (1,0,1, . . . )_{N} and (0,1,0, . . . )_{N} with N being the length of the respective non-singular feedback shift register.

13. The pseudo random number generator according to claim 12, wherein the plurality of non-singular feedback shift registers are of different lengths.

14. A method of generating a pseudo random number bit-sequence, the method comprising:
generating bit-sequences by use of a plurality of non-singular feedback shift registers each configured to output a respective one of the bit-sequences,
wherein at least a first of the plurality of non-singular feedback shift registers has one or more first cycles of a length less than or equal to two, and a second of the plurality of non-singular feedback shift registers has one or more second cycles of a length less than or equal to two, and
wherein the one or more first cycles encompass a first set of one or more of shift-register state vectors 000 . . . , 111 . . . , 010 . . . and 101 . . . and the one or more second cycles encompass a second set of one or more of the shift-register state vectors 000 . . . , 111 . . . , 010 . . . and 101 . . . with the first and the second set being disjoint.

15. The method according to claim 14, further comprising combining the plurality of bit-sequences of the plurality of non-singular feedback shift registers to a pseudo random output bit-sequence of the pseudo random number generator.

16. The method according to claim 14, wherein the first and the second non-singular feedback shift registers are of different lengths.

17. The method according to claim 14, wherein the first non-singular feedback shift register is of length N₁ and the second non-singular feedback shift register is of length N₂, and the first and second non-singular feedback shift registers are of different types among the types consisting of:
a FSR type comprising a cycle of length 1 comprising the shift-register state vector (1,1,1, . . . )_{N} and another cycle of length 2^{N}−1 comprising all vectors of F₂^{N} except (1,1,1, . . . )_{N},
a FSR type comprising a cycle of length 1 comprising the shift-register state vector (0,0,0, . . . )_{N} and another cycle of length 2^{N}−1 comprising all vectors of F₂^{N} except (0,0,0, . . . )_{N},
a FSR type comprising a first cycle of length 1 comprising the shift-registers state vector (1,1,1, . . . )_{N}, a second cycle of length 1 comprising the shift-register state vector (0,0,0, . . . )_{N}, and another cycle of length 2^{N}−2 comprising all vectors of F₂^{N} except (1,1,1, . . . )_{N}, and (0,0,0, . . . )_{N}, and
a FSR type comprising a cycle of length 2 comprising the shift-registers state vectors (1,0,1, . . . )_{N} and (0,1,0, . . . )_{N}, and another cycle of length 2^{N}−2 comprising all vectors of F₂^{N} except (1,0,1, . . . )_{N}, and (0,1,0, . . . )_{N},
with N ε {N1, N2}.

18. The method according to claim 15, wherein the combiner is configured to perform a Boolean operation on bits of the plurality of bit-sequences.

19. The method according to claim 15, wherein the combining comprises performing a non-linear operation on bits of the plurality of bit-sequences.

20. The method according to claim 15, wherein the combining comprises generating the pseudo random output bit-sequence at a bit-rate equal to 1/N of the sum of the bit-rates of the plurality of bit-sequences with N being the number of the plurality of non-singular feedback shift registers.

21. The method according to claim 15, further comprising selectively connecting inputs of the plurality of non-singular feedback shift registers with a seed source so that the plurality of feedback shift registers are, with the inputs connected to the seed source, seeded with the same seed.

22. A method of generating a pseudo random number bit-sequence, the method comprising:
generating bit-sequences by use of a plurality of non-singular feedback shift registers each configured to output a respective one of the bit-sequences, wherein the plurality of feedback shift registers comprises at least one non-singular feedback shift register having a cycle of length 2, comprising shift-register state vectors of (1,0,1, . . . )_{N} and (0,1,0, . . . )_{N} and another cycle of length 2^{N}−2 comprising all vectors of F₂^{N} except (1,0,1, . . . )_{N} and (0,1,0, . . . )_{N} with N being the length of the at least one non-singular feedback shift register.

23. A computer program for performing, when running on a processor, a method of generating a pseudo random number bit-sequence, the method comprising:
generating bit-sequences by use of a plurality of non-singular feedback shift registers each configured to output a respective on of the plurality of bit-sequences,
wherein at least a first of the plurality of non-singular feedback shift registers has one or more first cycles of a length less than or equal to two, and a second of the plurality of non-singular feedback shift registers has one or more second cycles of a length less than or equal to two, and
wherein the one or more first cycles encompass a first set of one or more of shift-register state vectors 000 . . . , 111 . . . , 010 . . . and 101 . . . and the one or more second cycles encompass a second set of one or more of the shift-register state vectors 000 . . . , 111 . . . , 010 . . . and 101 . . . with the first and the second set being disjoint.
